(19) United States
(12) Patent Application Publication
(10) Pub. No.: US 2013/0013378 A1
(43) Pub. Date: Jan. 10, 2013

(54) METHOD OF EVALUATING LOST REVENUE BASED ON WEB PAGE RESPONSE TIME

(76) Inventors: Jeremy Michael Norris, Duvall, WA (US); Aaron Roger Fossum, Auburn, WA (US); Phillip J. Chiappini, Issaquah, WA (US)

(21) Appl. No.: 13/331,964

(22) Filed: Dec. 20, 2011

Related U.S. Application Data
(60) Provisional application No. 61/505,930, filed on Jul. 8, 2011.

(51) Int. Cl. G06Q 10/00

(52) U.S. Cl. 705/7.38

(57) ABSTRACT

A method of determining a relationship between page response time and lost revenue. The method includes identifying a performance metric and determining a first relationship that indicates by how much changes in the value of the performance metric are attributable to changes in the value of the page response time. The method also includes determining a second relationship that indicates losses in revenue attributable to changes in the value of the performance metric. A third relationship is then determined which indicates losses in revenue attributable to changes in the value of the page response time. Optionally, a threshold lost revenue value may be used to determine a threshold page response time, which may be used to determine when corrective action should be taken to reduce page response time.

### CROSS REFERENCE TO RELATED APPLICATION(S)

This application claims the benefit of U.S. Provisional Application No. 61/505,930, filed Jul. 8, 2011, which is incorporated herein by reference in its entirety.

### BACKGROUND OF THE INVENTION

1. Field of the Invention

The present invention is directed generally to methods of evaluating the effect of application performance on revenue generated by an application, and more particularly, to methods of evaluating the effect of webpage response time on revenue generated by the webpage.

2. Description of the Related Art

Currently available website analysis tools provide information to operators of websites that is useful when evaluating website performance. Unfortunately, these tools do not tie many objective website performance metrics (e.g., page response time) to financial performance (e.g., revenue). Because websites can generate significant income for their operators, a need exists for methods of evaluating the effect of objective website performance metrics on financial performance of the website. The present application provides this and other advantages as will be apparent from the following detailed description and accompanying figures.

### BRIEF DESCRIPTION OF THE SEVERAL VIEWS OF THE DRAWING(S)

FIG. 1 is a diagram of a system for determining a portion of revenue that was lost by a page of a website as a result of an unacceptable (e.g., long) page response time (“PRT”).

FIG. 2 is a plot of daily bounce rates for a page for two different web browsers.

FIG. 3 is a plot of daily average PRT values for the page for the two different web browsers.

FIG. 4 is a flow diagram of a method of estimating an unrealized portion of revenue that would have been generated by a website if one or more pages of the website had an acceptable (e.g., shorter) PRT.

FIG. 5 is a flow diagram of a method of determining attribution levels for PRT values.

FIG. 6 is a plot of daily average PRT values for a page for two different web browsers.

FIG. 7 is a graph of lost revenue for the page attributable to PRT.

FIG. 8 is a plot of daily average PRT values for a page for two different web browsers divided into three groups.

FIG. 9 is an exemplary plot of attribution levels assigned to PRT values and a plot of a curved line representing a model of attribution level as a function of PRT value.

FIG. 10 is a flow diagram of a method of monitoring website performance using information generated by the method of FIG. 4.

FIG. 11 is an illustration of an example dashboard style interface that may be used to display PRT values and an amount of revenue loss caused by PRT.

FIG. 12 is a diagram of a hardware environment and an operating environment in which elements of the system of FIG. 1 and one or more of the methods of FIGS. 4, 5, and 10 may be implemented.

FIG. 13 is a diagram that illustrates examples of events that may be used as start and end points for PRT.

### DETAILED DESCRIPTION OF THE INVENTION

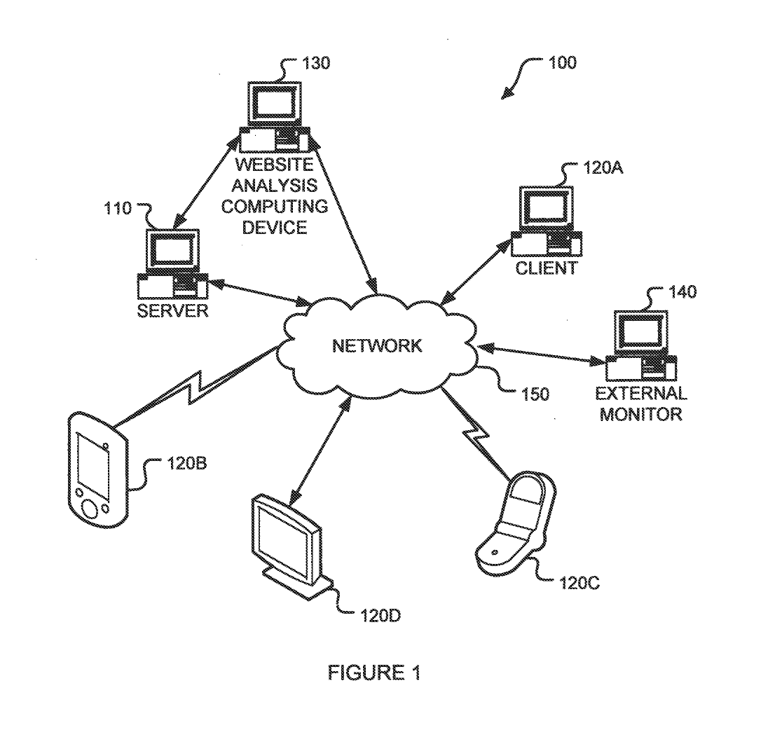

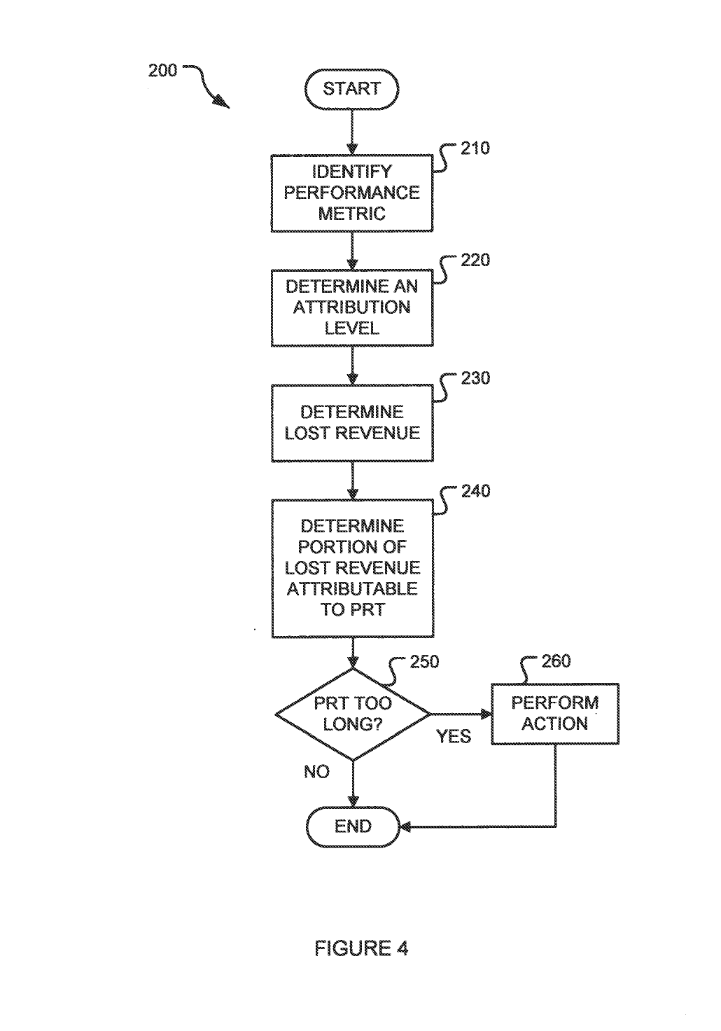

As used herein, the term “page” refers to web pages, screens, and other types of user interface elements displayed on a computing device. For illustrative purposes, a system 100 illustrated in FIG. 1 and methods 200, 300, and 400 illustrated in FIGS. 4, 5, and 10, respectively, are described for use with respect to a website implementation. However, in alternate implementations, the system 100, and/or one or more of the methods 200, 300, and 400 may be used with other applications that display information to users in pages, such as a mobile applications, and the like.

### System 100

FIG. 1 is an illustration of the system 100. The system 100 includes at least one server computing device 110 (e.g., a conventional web server), and at least one client computing device (e.g., client computing devices 120A-120D). Optionally, the system 100 may also include at least one website analysis computing device 130, and at least one external application monitoring computing device 140. The server computing device 110 is connected to the client computing devices 120A-120D by a network 150 (e.g., the Internet). In embodiments including at least one external application monitoring computing device 140, the server computing device 110 is connected to the external application monitoring computing device(s) 140 by the network 150. The server computing device 110 may also be connected to the optional website analysis computing device 130 by the network 150 or another communication link.

The server computing device 110 is configured to provide a website, mobile application, and the like to the client computing devices 120A-120D and/or the optional external application monitoring computing device(s) 140. Thus, in embodiments in which the server computing device 110 provides a website, the server computing device 110 includes conventional web server components and related files operable to display the website on the client computing devices 120A-120D. While the system 100 is illustrated as including the single server computing device 110, those of ordinary skill in the art appreciate that the system 100 may include any number of server computer devices that each perform the functions of the server computing device 110 or cooperate with one another to perform those functions.

While the server computing device 110 is illustrated as being connected to the four client computing client computing devices 120A, 120B, 120C, and 120D, those of ordinary skill in the art appreciate that the server computing device 110 may be connected to any number of client computing devices and the server computing device 110 is not limited to use with any particular number of client computing devices.

The client computing devices 120A-120D are each operated by a user of the website, mobile application, or the like provided by the server computing device 110. Thus, in embodiments in which the server computing device 110 provides a website, the client computing devices 120A-120D each include a conventional web browser configured to display the website. By way of non-limiting examples, in FIG. 1, the client computing device 120A is illustrated as a personal computer (e.g., a laptop, tablet personal computer, and the like), the client computing device 120B is illustrated as a personal digital assistant, the client computing device 120C is illustrated as a cellular telephone, and the client computing device 120D is illustrated as an Internet enabled television. The client computing devices 120A-120D may be located remotely from the server computing device 110.

The optional website analysis computing device 130 may be used to implement internal monitoring tools that evaluate a website from the viewpoint of the organization operating the website. While the system 100 is illustrated as including the single website analysis computing device 130, those of ordinary skill in the art appreciate that the system 100 may include any number of website analysis computer devices that each perform the functions of the website analysis device 130 or cooperate with one another to perform those functions. In some embodiments, all or a portion of the internal monitoring tools may be executed by the server computing device 110. The internal monitoring tools may include conventional website analytics tools, such as Adobe® SiteCatalyst® web analytics software available from Adobe Systems Incorporated of San Jose, Calif., and may be used by an operator of a website to monitor the website and collect website performance data. For example, such software may be configured to determine an amount of revenue generated by a particular webpage, a number of bounces experienced by the particular webpage over a predetermined period of time, and the like. A “bounce” occurs when a user exits a page without navigating to another page of the same website or mobile application. Within a predetermined time period, the number of users that bounce divided by the total number of users yields a “bounce rate” that may be expressed as a percentage of the total number of users.

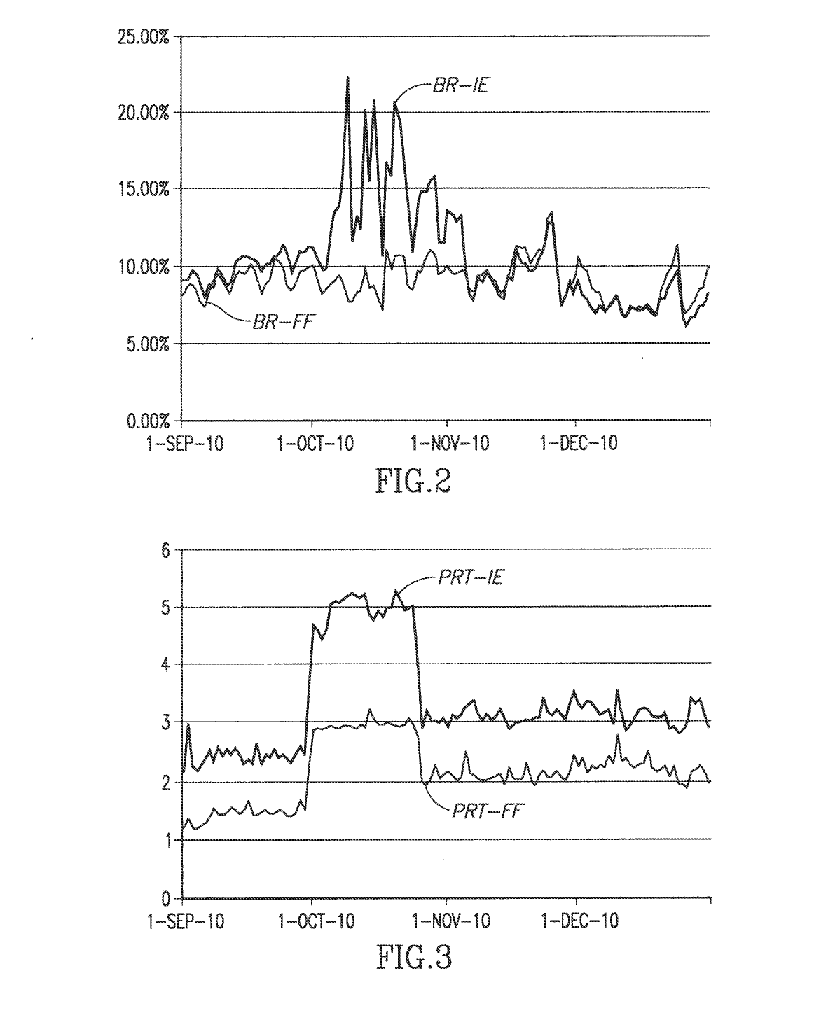

By way of a non-limiting example, FIG. 2 provides is a graph created using data collected by the internal monitoring tools. In FIG. 2, a first line “BR-IE” is a plot of a daily bounce rate for a first web browser (Internet Explorer) for a home page of a website and a second line “BR-FF” is a plot of a daily bounce rate for a second web browser (Firefox) for the same home page of the same website. The first and second lines “BR-IE” and “BR-FF” each plot the daily bounce rate (as a percentage) as a time series from Sep. 1, 2010 to Jan. 10, 2011. The line “BR-IE” indicates a significant increase in the daily bounce rate occurred between Oct. 10, 2010 and Nov. 10, 2010.

The optional external application monitoring computing device(s) 140 may be used to implement external monitoring tools that evaluate a website or mobile application from the viewpoint of its users. In other words, external monitoring tools view the website or mobile application from outside the organization that operates the website or mobile application. Thus, in embodiments in which the server computing device 110 provides a website, each external application monitoring computing device includes a conventional web browser configured to display the website. External monitoring tools may perform synthetic website monitoring, such as that performed by Gomez Networks owned by Compuware Corporation of Lansing, Mich., which generates artificial user activity and uses that activity to evaluate the performance of the website. In some embodiments, all or a portion of the external monitoring tools may be executed by the client computing devices 120A-120D. The external monitoring tools may be used to determine page response time (“PRT”) for each of a plurality of pages of a website.

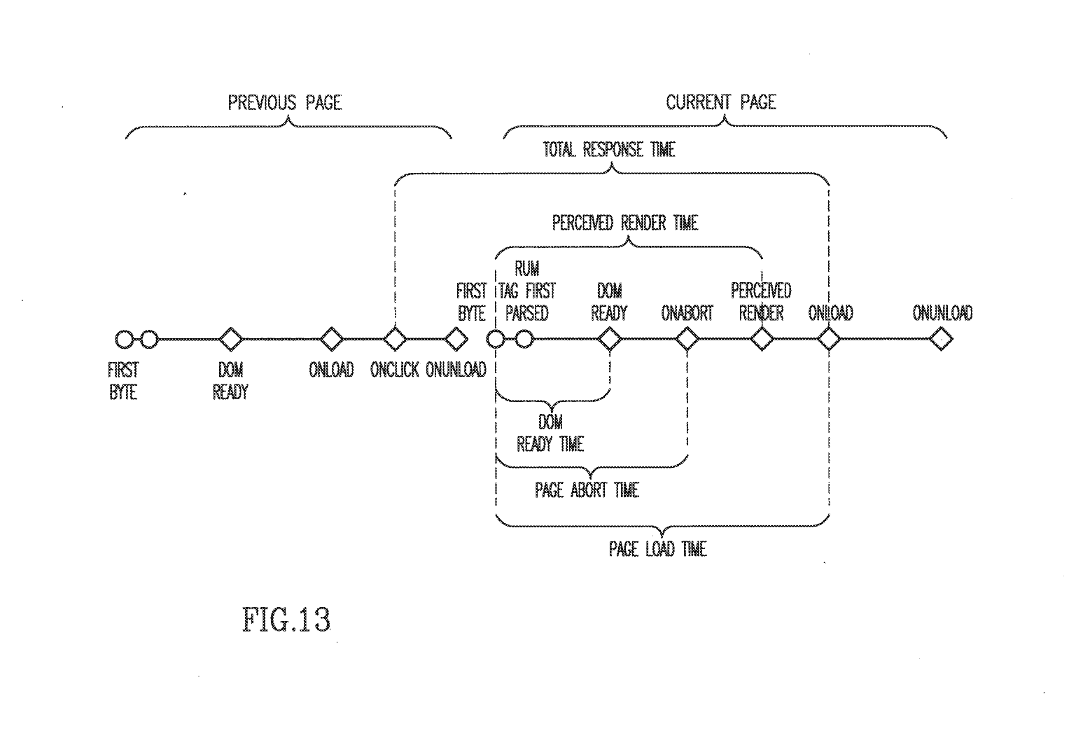

FIG. 13 illustrates non-limiting examples of events that may be used as start and end points for PRT. FIG. 13 illustrates a previous page (labeled “PREVIOUS PAGE”) and a current page (labeled “CURRENT PAGE”). From left to right, the events of the previous page include a first byte is sent event (marked with a first circle and labeled “FIRST BYTE”), a real user monitoring (“RUM”) tag is first parsed event (marked with a second circle and unlabeled), a document object model (“DOM”) ready event (marked with a first diamond and labeled “DOM READY”), an onload event (marked with a second diamond and labeled “ONLOAD”), an onclick event (marked with a third diamond and labeled “ONCLICK”), and an onunload event (marked with a fourth diamond and labeled “ONUNLOAD”). The onabort event measures at what time the user aborts the render process. From left to right, the events of the current page include a first byte is sent event (marked with a first circle and labeled “FIRST BYTE”), a RUM tag is first parsed event (marked with a second circle and labeled “RUM TAG FIRST PARSED”), a DOM ready event (marked with a first diamond and labeled “DOM READY”), an onabort event (marked with a second diamond and labeled “ONABORT”), a perceived render event (marked with a fourth diamond and labeled “PERCEIVED RENDER”), an onload event (marked with a fourth diamond and labeled “ONLOAD”), and an onunload event (marked with a fifth diamond and labeled “ONUNLOAD”).

In particular implementations, the term “PRT” may refer to one of the following metrics or a combination thereof:
a.) a total page response time, which is an amount of time that elapses from when a link to the page is clicked (or an onclick event is triggered) on the previous page to when the current page has completed loading (or an onload event is triggered on the current page);
b.) a perceived render time, which is an amount of time that elapses from when a first byte of the page is sent (or a first byte is sent event is triggered) to the user to when the page is perceived by the user as having completed rendering (or a perceived render event is triggered);
c.) a DOM ready time, which is an amount of time that elapses from when a first byte of the page is sent to a user (or a first byte is sent event is triggered) to when the DOM is ready (or a DOM ready event is triggered);
d.) a time to first byte, which is an amount of time that elapses from when a link to the page is clicked (or an onclick event is triggered) on a previous page to when the first byte is sent to the user (or a first byte is sent event is triggered);
e.) a page abort time, which is an amount of time that elapses from when a first byte of the page is sent to the user (or a first byte is sent event is triggered) to when the page has completed aborting (or an onabort event is triggered); and
f.) a page load time, which is an amount of time that elapses from when a first byte of the page is sent to the user (or a first byte is sent event is triggered) to the page has completed loading (or an onload event is triggered).
   Perceived render time measures the amount of time to render objects above the fold. “Above the fold” refers to content that the user does not have to scroll down to interact with. To capture the perceived render event, it may be necessary to also capture the height and width of the browser window. The DOM ready time measures an amount of time required to receive all of the objects in the DOM. Because the DOM may control the layout of the page, objects often start rendering before the DOM ready, but are not positioned in their proper location until the DOM is ready.

The external monitoring tools may be used to determine PRT for different web browsers, PRT for users located in different geographic regions, PRT for different devices, PRT for different operating systems, PRT for different browser window dimensions (height and width), PRT for different screen resolutions, PRT for different Internet service providers, and the like. Data collected by the external monitoring tools is sent to the server computing device 110 and/or the optional website analysis computing device 130.

By way of a non-limiting example, FIG. 3 is a graph created using data collected by the external monitoring tools. In FIG. 3, the PRT values used are total page response times. In FIG. 3, a first line “PRT-IE” is a plot of a daily average PRT values for a first web browser (Internet Explorer) for a home page of a website and a second line “PRT-FF” is a plot of a daily average PRT values for a second web browser (Firefox) for the same home page of the same website. The first and second lines “PRT-IE” and “PRT-FF” each plot the daily average PRT values (in seconds) as a time series from Sep. 1, 2010 to Jan. 10, 2011. The first and second lines “PRT-IE” and “PRT-FF” each indicate a significant increase in the daily average PRT occurred between Oct. 10, 2010 and Nov. 10, 2010. Thus, FIGS. 2 and 3 indicate a correlation between an increase in the daily average PRT value and an increase in the daily average bounce rate for the home page of the website.

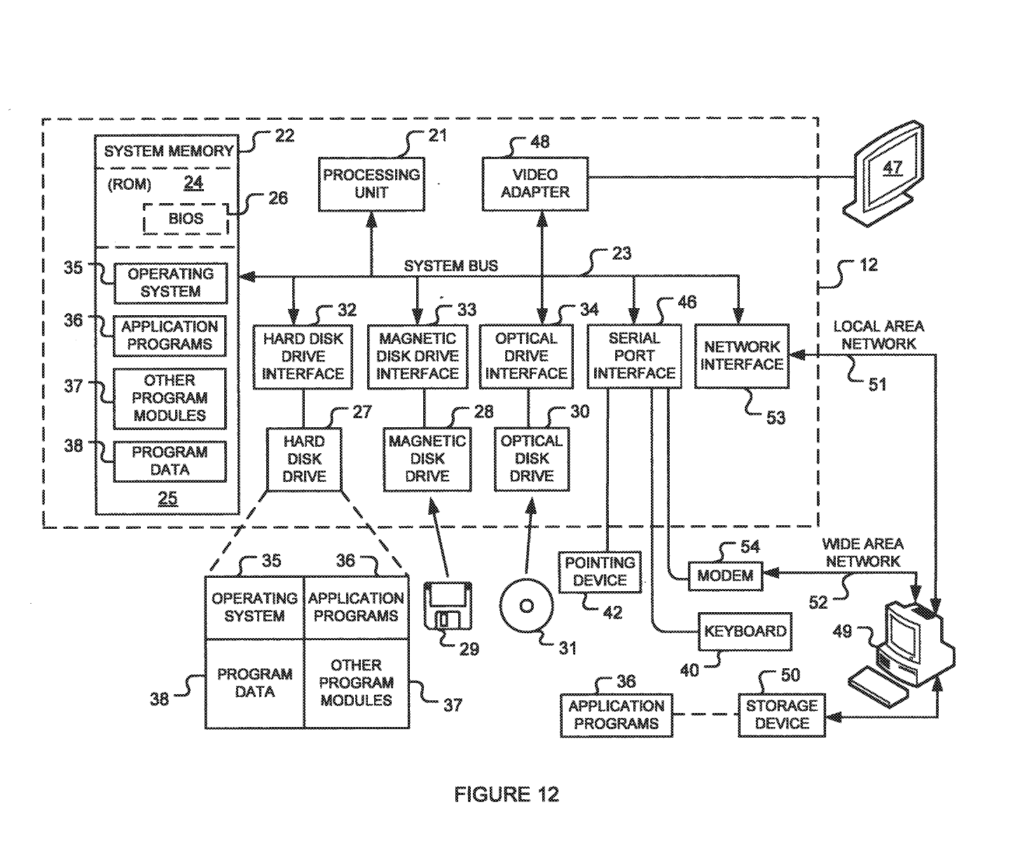

A diagram of hardware and an operating environment in conjunction with which implementations of the server computing device 110, the client computing devices 120A-120D, the optional website analysis computing device 130, the optional external application monitoring computing device(s) 140, and the network 150 may be practiced is provided in FIG. 12 and described below.

### Method 200

FIG. 4 is a flow diagram of the method 200 of estimating an unrealized portion of revenue that would have been generated by a website had one or more pages of the website had a more acceptable (e.g., shorter) PRT. In other words, the method 200 estimates revenue lost by an operator of a website as a result of an unacceptable (e.g., long) PRT. Thus, the method 200 may be characterized as tying PRT to lost revenue or lost business opportunities. All or portions of the method 200 may be performed by the website analysis computing device 130 (see FIG. 1) and/or the server computing device 110 (see FIG. 1).

In first block 210, a performance metric is identified for each of one or more pages of a website. Within a webpage or mobile application, different pages perform different functions. For example, on a website, a homepage generally serves as a gateway to other web pages. In this example, if a user exits a homepage without navigating to other web pages, the homepage has been unsuccessful with respect to that user. As mentioned above, this behavior is referred to as “bouncing.” As also mentioned above, the number of users that bounce divided by the total number of users yields a “bounce rate” that may be expressed as a percentage of the total number of users. Bounce rate may be used as a performance metric for a homepage and/or similar web pages designed to route users to other web pages. Similarly, bounce rate may be used as a performance metric for pages or screens of an application designed to route users to other portions of the application. If the website, mobile application, or the like is configured to generate revenue (e.g., provides a service, offers goods for sale, and the like), the webpage or mobile application may lose revenue when a user bounces because the user may have planned to spend money on the website but exited before doing so. In other words, revenue is inversely correlated with bounce rate.

If a page of a website takes too long to respond (e.g., display in a web browser), many users may simply exit the webpage and may possibly exit the website. Thus, as illustrated by FIGS. 2 and 3, bounce rate is correlated with PRT. Therefore, revenue is also correlated with PRT. PRT may vary between different types of browsers.

For routing pages (e.g., homepages), the performance metric may be bounce rate over a period of time (e.g., daily, hourly, weekly, etc.). For product pages, the performance metric may be an add rate. The add rate may be calculated by dividing a number of times an item for sale (e.g., a product, a service, and the like) is viewed over a period of time (e.g., daily, hourly, weekly, etc.) by a number of times the item was added to a shopping cart over the same period of time. For a shopping cart, the performance metric may be an order completion rate. The order completion rate may be calculated by dividing the total number of orders initiated by users (e.g., items were added to the shopping cart) over a period of time (e.g., daily, hourly, weekly, etc.) by the average number of orders completed by users over the same period of time. For a user search page, the performance metric may be a search result click-through rate. The search result click-through rate may be calculated by dividing a number of search result pages viewed over a period of time (e.g., daily, hourly, weekly, etc.) by a number of search results the user clicked through to view the page identified by the search. By way of a non-limiting example, each page may be associated with a page style or type (e.g., using a template). Then, a performance metric may be assigned to each page type. The value of the performance metric may be obtained from the internal monitoring tools.

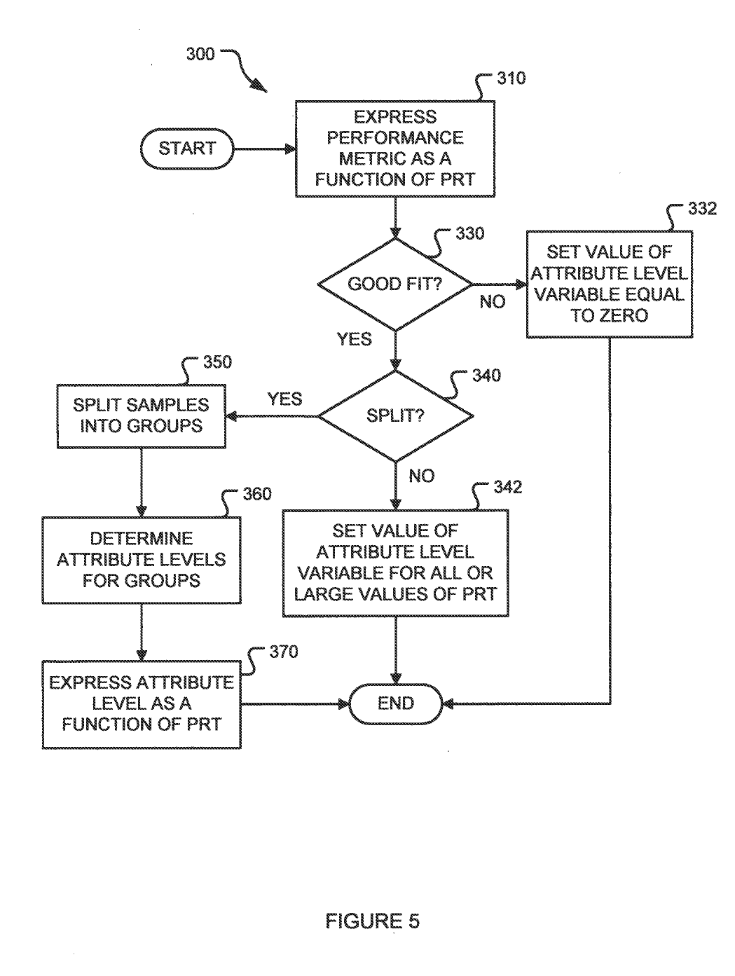

In block 220, an attribution level is determined for each page (or type of page) that indicates how much of a change in the performance metric may be attributed to a change in PRT. For example, not all of the bouncing may be caused by an unacceptable PRT. An amount by which the performance metric changes as a function of PRT may be determined using the method 300 illustrated in FIG. 5 (discussed below). Using the method 300, changes in the performance metric (e.g., the bounce rate) attributable to changes in PRT are determined and stored in an attribution level variable “AL.” By way of a non-limiting example, the method 300 may have determined that 30% of a change in the performance metric is attributable to a change in PRT. In this example, in block 220, a value of 30% is assigned to the attribution level variable “AL.”

Returning to FIG. 4, in block 230, a percentage of lost revenue for each page is determined. By way of a non-limiting example, the percentage of lost revenue for the page may be stored in a variable “% ΔREV_{PM}.” The value of the variable “% ΔREV_{PM}” may be calculated using Formula A below:

$$\% Δ {REV}_{PM} = \frac{( {REV}_{T} - {REV}_{A} )}{{REV}_{A}} \qquad ( Formula A )$$

The variable “REV_{A}” stores actual revenue generated by the page over a period of time and the variable “REV_{T}” stores a target revenue for the page over the same period of time. The value of the variable “REV_{T}” may be determined using Formula B below:

REV_{T}=(Sv_{T}−Sv_{A})*RPSv (Formula B)

The variable “Sv_{A}” stores a total actual number of non-single access visits to the page over the period of time and the variable “Sv_{T}” stores a target number of non-single access visits over the same period of time. Values for these variables may be determined using Formulas C and D:

Sv_{A}=Visits*(1−PM_{A}) (Formula C)

Sv_{T}=Visits*(1−PM_{T}) (Formula D)

The variable “RPSv” stores revenue per non-single access visit over the period of time. The value of the variable “RPSv” may be determined using the following Formula E:

$$RPSv = \frac{{REV}_{A}}{{Sv}_{A}} \qquad ( Formula E )$$

The variable “PM_{A}” stores an actual value of the performance metric. The variable “PM_{T}” stores a target value of the performance metric. The value of the variable “PM_{T}” may determined based on historical values of the performance metric. For example, the value of the variable “PM_{T}” may be equal to a 30-day rolling average of the performance metric. Thus, if the performance metric for the page is daily bounce rate, the value of the variable “PM_{T}” for the page may be set each day to the 30-day rolling average of the daily bounce rate for the page.

In block 240, a portion (e.g., a percentage) of lost revenue attributable to the PRT is determined for each page. Formula F below may be used to determine a portion of lost revenue (attributable to PRT) as a function of a change in the PRT and a change in the performance metric identified for the page:

% ΔREV_ATTRIBUTABLE_TO_ΔPRT=% ΔREV_{PM}×AL (Formula F)

Using Formula F, if over a predetermined period of time, the value of the variable “ % ΔREV_{PM}” was 1.8% and the value of the variable “AL” was 30%, about 0.6% of the revenue lost by the page over the predetermined period of time was lost as a result of PRT. As will be discussed below, the value of the variable “AL” may increase as the length of the PRT increases to reflect that a greater portion of lost revenue is attributable to PRT.

In decision block 250, for each page, whether the PRT is too long (i.e., causing the page to lose too much revenue) is determined. For example, the relationship between the PRT and revenue may be used to set threshold values for the PRT for each page (or type of page). The operator of the website may select an acceptable value of the variable “AL” and set the threshold value equal to the longest PRT that was assigned the acceptable value of the variable “AL.”

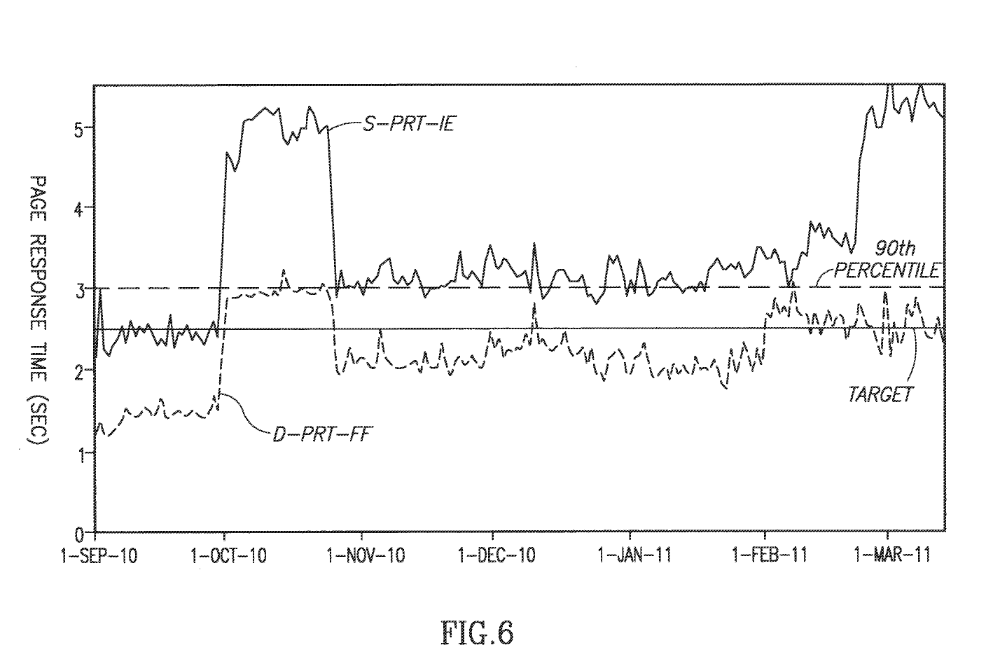

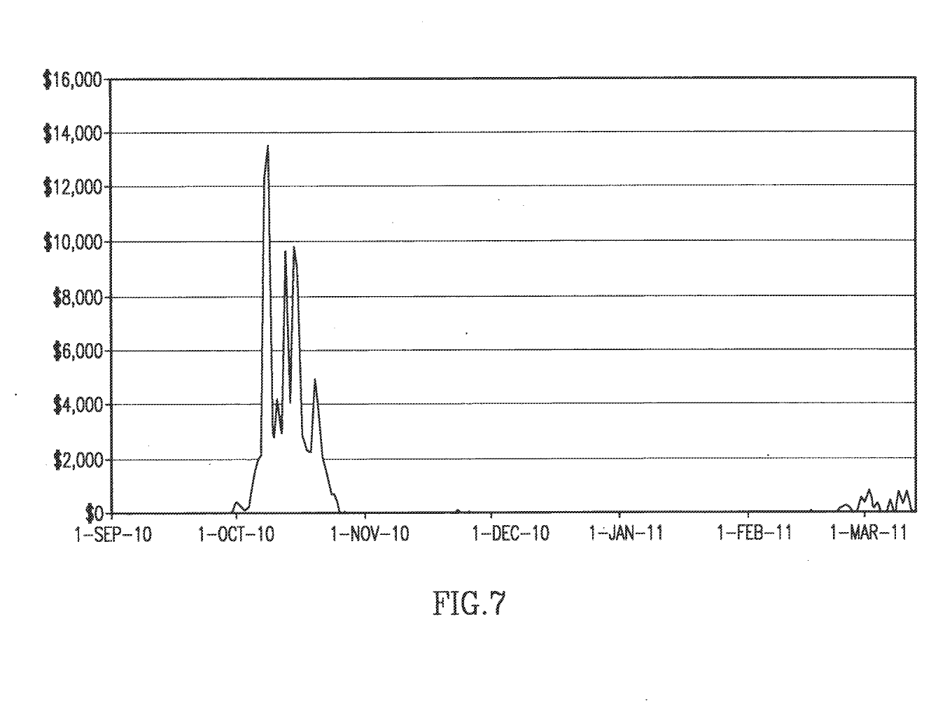

By way of a non-limiting example, in FIG. 6, a solid line “S-PRT-IE” is a plot of a daily average PRT for a first web browser (Internet Explorer) for a home page of a website and a dotted line “D-PRT-FF” is a plot of a daily average PRT for a second web browser (Firefox) for the same home page of the same website. In FIG. 6, the PRT values used are total page response times. The solid line “S-PRT-IE” and the dotted line “D-PRT-FF” each plot PRT (in seconds) as a time series from Sep. 1, 2010 to May 25, 2011. The lines “S-PRT-IE” and “D-PRT-FF” each indicate a first significant increase in daily average PRT occurred between Sep. 10, 2010 and Oct. 27, 2010 and a second significant increase in daily average PRT occurred between Feb. 16, 2010 and May 25, 2011. FIG. 7 is a graph of lost revenue attributable to PRT. FIG. 7 illustrates increases in lost revenue that occurred during the first and second significant increase in daily average PRT.

Returning to FIG. 6, a line labeled “90^{th} PERCENTILE” or a line labeled “TARGET” may be used as a threshold. The decision in decision block 250 may be “YES” when the daily average PRT exceeds this threshold. The line labeled “TARGET” represents a target PRT (which may be stored in a variable “PRT_{T}”). The value of the target PRT for the page may be determined by analyzing the historical impact of PRT on the value of the performance metric (e.g., the bounce rate) and identifying a value at which the PRT begins to consistently affect the value of the performance metric. In other words, the target PRT may be set to a point at which PRT caused a measurable and consistent change in the performance metric.

The line labeled “90^{th} PERCENTILE” represents a different target value that may be less difficult to achieve. For example, if a page cannot be modified such that its daily average PRT is under the PRT target, the 90^{th} percentile could be used as a target instead. The 90th percentile may be set to a point at which a meaningful revenue loss is observed. The operator of the website may determine how much revenue loss is considered to be meaningful. In other words, the operator of the website may select a level of meaningful revenue loss. The PRT values collected for the page for the first and second web browsers may be combined when the 90^{th} percentile is calculated for the PRT of the page.

For each page, the decision in decision block 250 is “YES” when the PRT is determined to be too long. On the other hand, the decision in decision block 250 is “NO” when the PRT is determined not to be too long.

When the decision in decision block 250 is “YES,” an action may be taken in block 260. For example, a developer or other party responsible for the page may be notified so that the page can be modified to decrease its PRT. By way of another example, the server computing device 110 may be modified to improve its performance and decrease its PRT. By way of another example, additional resources (e.g., bandwidth, computing devices, and the like) may be allocated to the page to decrease its PRT. After block 260, the method 200 terminates.

When the decision in decision block 250 is “NO,” the method 200 terminates.

In addition to analyzing historical data, the relationship between the PRT and revenue may be used to estimate how much a change in the PRT would effect future revenue generated by a page. Such estimates may be used to evaluate the cost effectiveness of implementing particular features, adding content, and the like.

### Method 300

FIG. 5 is a flow diagram of the method 300, which provides an example of a method of determining the value of the attribution level variable “AL.” However, as is apparent to those of ordinary skill in the art, alternate methods of determining the value of the attribution level variable “AL” may be used and the method 200 is not limited to using the method 300 to determine the value of the attribution level variable “AL.” All or portions of the method 300 may be performed by the website analysis computing device 130 (see FIG. 1) and/or the server computing device 110 (see FIG. 1).

In first block 310, a statistical analysis (e.g., a simple linear regression) is used to express the performance metric as a function of the PRT. In such embodiments, the performance metric (which is a dependent variable represented by a variable “y”) is expressed as a function of the PRT (which is the independent variable represented by a variable “x”). When the statistical analysis is a simple linear regression, a Formula G provided below may be used to express the dependent variable “y” as a function of the independent variable “x:”

ŷ=Xb₁+b₀ (Formula G)

The values of the coefficient variables “b₁” and “b₀” may be obtained by applying conventional techniques to data collected from the website or mobile application. For illustrative purposes, the data will be described as including a number of samples represented by a variable “n.” The data includes pairs of values of the performance metric (e.g., daily bounce rate) and the PRT (e.g., daily average PRT). For example, the sample data may include a plurality of bounce rates each associated with a PRT value.

If a simple linear regression is used, a variance “R²” (sometimes referred to as a coefficient of determination) having a value within a range of zero to one may also be calculated. The variance “R²” expresses a percentage (or portion) of change in the performance metric that can be explained by variance in the PRT. By way of a non-limiting example, a Formula H provided below may be used to calculate the variance “R².”

$${R}^{2} = 1 - \frac{{\sum }_{i = 1}^{n} {( {y}_{i} - {\hat{y}}_{i} )}^{2}}{{\sum }_{i = 1}^{n} {( {y}_{i} - \overline{y} )}^{2}} \qquad ( Formula H )$$

In Formula H, the variable “ŷᵢ” represents the value calculated (or predicted) by the Formula G for the i^{th} value of the independent variable “x,” and the variable “y” represents a mean value of the dependent variable “y” (e.g., the performance metric) for the samples.

The Formula G and the values determined for the coefficient variables “b₁” and “b₀” may be characterized as modeling the performance metric based on the PRT. In decision block 330, whether the model is a good fit for the sample data collected is determined. The decision in decision block 330 is “YES” when the model is determined to be a good fit. On the other hand, the decision in decision block 330 is “NO” when the model is determined not to be a good fit. As is apparent to those of ordinary skill in the art, statistical significance of the “fit” of such a model may be determined using conventional statistical techniques (e.g., an F-test). By way of a non-limiting example, the decision in decision block 330 may be “NO” when the significance of the model determined using the selected significance technique is below a selected significance level (e.g., 95%). On the other hand, the decision in decision block 330 may be “YES” when the significance of the model determined using the selected significance technique is at or above a selected significance level (e.g., 95%).

When the decision in decision block 330 is “NO,” in block 332, the value of the attribution level variable “AL” is set to zero. Alternatively, a new model (e.g., a multiple regression) may be selected. By way of yet another non-limiting example, more data may be collected to improve the fit of the linear model. Then, the method 300 terminates.

When the decision in decision block 330 is “YES,” decision block 340 is evaluated. In decision block 340, whether the data samples should be split into groups is determined. The decision in decision block 340 is “NO,” when the PRT of the data samples for the page is relatively constant or only a limited number of samples have been collected making dividing the data impractical because of an unacceptable impact on precision. Otherwise, the decision in decision block 340 is “YES.”

When the decision in decision block 340 is “NO,” in block 342, the value of the attribution level variable “AL” may be set to the variance “R²” for all or only large values of the PRT (e.g., PRT values greater than mean of the PRT of the samples, PRT values greater than the 90^{th} percentile of the PRT of the samples, and the like). PRT values not assigned the value of the variance “R²” may be assigned a value of zero. This technique may work well when the PRT for the page is relatively constant or only a limited number of samples have been collected making dividing the data impractical because of an unacceptable impact on precision. On the other hand, when there is a significant amount of variance in the PRT of the data samples, the attribution level may not be adequately described by one or two values (e.g., the variance “R²” and zero). Generally, the attribution level will increase as the PRT increases. Thus, when the PRT for the page is not relatively constant and a sufficient number of samples of the PRT and the performance metric have been collected, the decision in decision block 340 is “YES.”

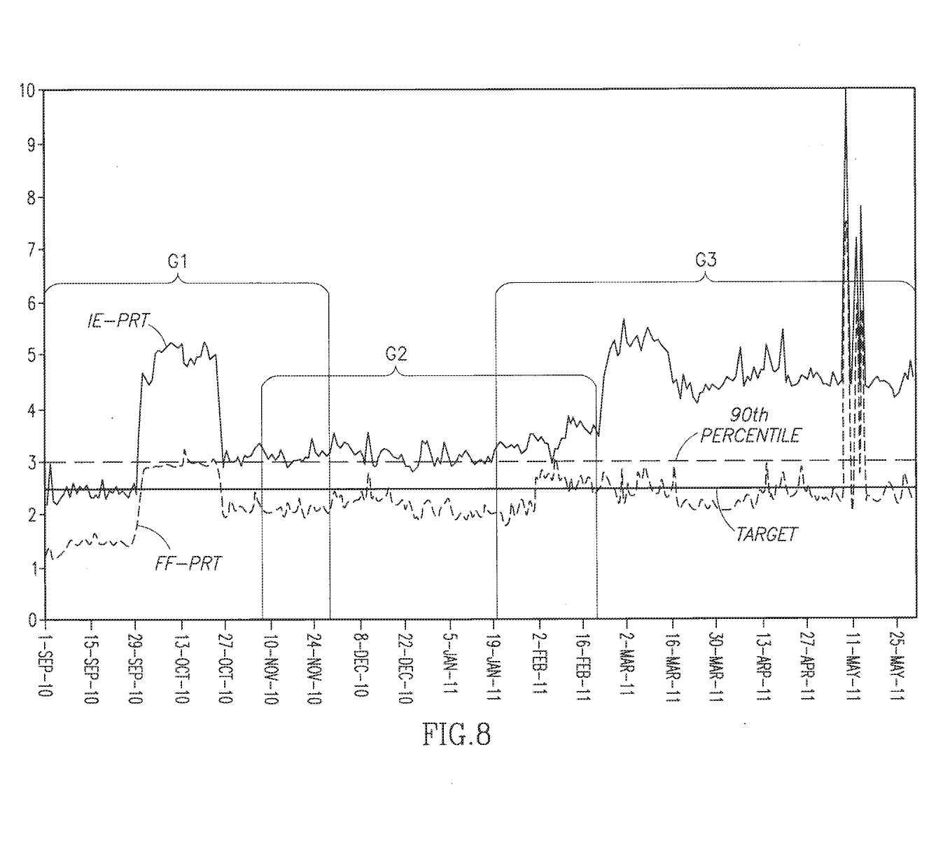

When the decision in decision block 340 is “YES,” in block 350, the samples are divided into groups. Each group may include a subset of the series of samples collected. Within each subset, the samples may be contiguous and have relatively constant PRT values. FIG. 8 illustrates plots of daily average PRT of a page of a website. In FIG. 8, the PRT values used are total page response times. In FIG. 8, a solid line “IE-PRT” is a plot of a daily average PRT for a first web browser (Internet Explorer) for the page of the website and a dotted line “FF-PRT” is a plot of a daily average PRT for a second web browser (Firefox) for the same page of the same website. The solid line “IE-PRT” and the dotted line “FF-PRT” each plot PRT (in seconds) as a time series from Sep. 1, 2010 to May 25, 2011. The lines “IE-PRT” and “FF-PRT” each indicate a first significant increase in daily average PRT occurred between Sep. 29, 2010 and Oct. 27, 2010 and a second significant increase in daily average PRT occurred between Feb. 16, 2010 and May 25, 2011. Thus, in FIG. 8, the data samples plotted to generate the lines “IE-PRT” and “FF-PRT” can be divided into three groups “G1,” “G2,” and “G3.” Within each of the groups “G1,” “G2,” and “G3,” the variance in the daily average PRT is less than the variance across all of the data samples.

Then, in block 360, an attribution level is determined for each group. A separate simple linear regression analysis may be performed on the samples of each group and used to calculate an attribution level for the group. The attribution level may be the variance “R²” calculated for each group. The attribution level may be assigned to all PRT values within the group or only large PRT values within the group (e.g., PRT values greater than mean of the PRT of the samples, PRT values greater than the 90^{th} percentile of the PRT of the samples, the largest PRT value, and the like). PRT values not assigned the value of the variance “R²” may be assigned a value of zero. This technique may work well because within a group, the PRT is relatively constant.

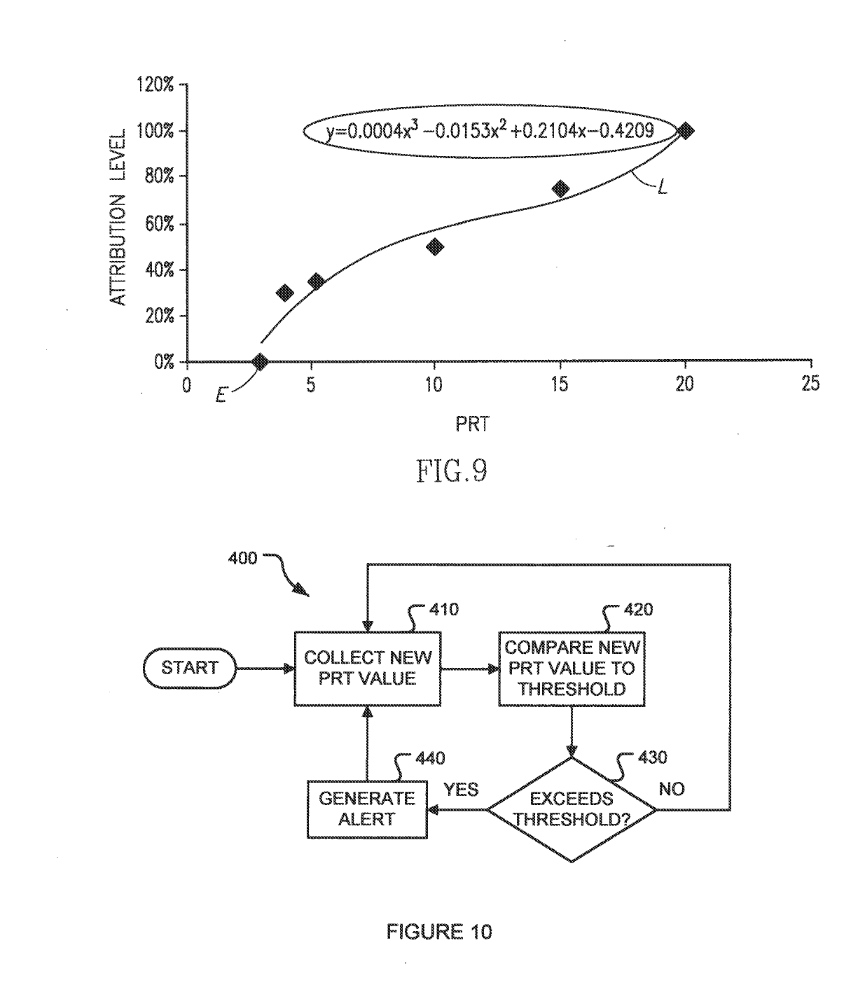

In block 370, a statistical analysis may be used to model attribution level as a function of PRT. The model may then be used to determine an attribution level for a particular PRT value. Each of the PRT values assigned an attribution level in block 360 may be used to create a model (e.g., a mathematical expression) of attribution level as a function of the PRT. FIG. 9 is an exemplary plot of PRT values and their assigned attribution levels. In FIG. 9, the PRT values used are total page response times. Optionally, PRT values assigned an attribution level of zero may be omitted from the analysis. A data element “E” may be added (to the data used generate the model) for the value of the target PRT (represented by the variable “PRT_{T}”) and assigned an attribution level of zero. In FIG. 9, a curved line “L” illustrates a model (in this case a multiple linear regression) that expresses attribution level as a function of PRT. The mathematical equation represented by the curved line “L” is as follows:

Y=0.0004X³−0.0153X²+0.2104X−0.4209.

In the above equation, the variable “Y” is the dependent variable (or attribution level) and the variable “X” is the independent variable (or PRT).

Then, the method 300 terminates.

### Method 400

FIG. 10 is a flow diagram of a method 400 of monitoring website performance using the information generated using the method 200 illustrated in FIG. 4. All or portions of the method 400 may be performed by the website analysis computing device 130 (see FIG. 1) and/or the server computing device 110 (see FIG. 1).

In first block 410, a new PRT value (e.g., a new daily average PRT) is obtained from one or more external monitoring tools for one or more pages of a website. As mentioned above, the relationship between the change in the PRT and a portion of lost revenue attributable to that change may be used to establish a threshold value for the PRT for each page. In particular implementations, the new PRT value is received from the external application monitoring computing device 140 (see FIG. 1).

In block 420, the new PRT value may be compared to the threshold value. Optionally, the new PRT value and the threshold value may be displayed using a graphical user display. For example, a dashboard style interface may be used to display a dial that includes a needle representing the new (or current) value for the PRT. The needle may rotate as the PRT value changes. The dial may have a “red zone” that indicates an unacceptable loss in revenue is occurring as a result of excessive PRT.

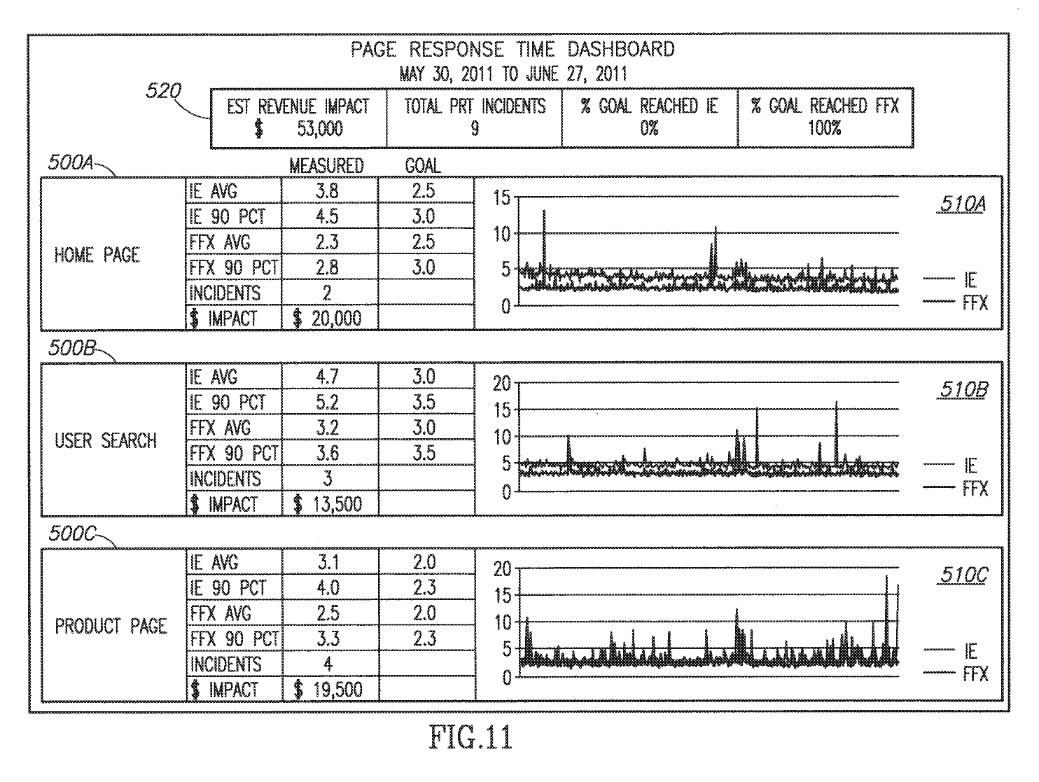

FIG. 11 illustrates an example dashboard style interface that does not include dials and displays measured PRT values in tables 500A to 500C and plots 510A to 510C. In FIG. 11, the PRT values used are total page response times. In the tables 500A to 500C, PRT information is provided for three pages types, homepage, user search, and product page, respectively. Within each of the tables 500A to 500C, in a column labeled “MEASURED,” an average of the daily average PRT values over a predetermined time period for each browser is displayed in rows labeled “IE AVG” and “FFX AVG,” a 90th percentile value for the daily average PRT values over the predetermined time period for each browser is displayed in rows labeled “IE 90 PCT” and “FFX 90 PCT,” an estimated revenue loss caused by PRT for all browsers is displayed in a row labeled “$ IMPACT,” and a total number of response time incidents for all browsers is displayed in a row labeled “INCIDENTS.” A response time incident occurs when PRT is greater than the acceptable threshold.

Within each of the tables 500A to 500C, in a column labeled “GOAL,” a target value for the average of the daily average PRT values over the predetermined time period for each browser is displayed in the rows labeled “IE AVG” and “FFX AVG,” and a target value for the 90th percentile value for the daily average PRT values over the predetermined time period for each browser is displayed in the rows labeled “IE 90 PCT” and “FFX 90 PCT.”

FIG. 11 also includes a summary table 520 that lists estimated revenue loss for all browsers and page types caused by PRT in a cell labeled “EST REVENUE IMPACT” and a number of response time incidents for all browsers and page types in a cell labeled “TOTAL PRT INCIDENTS.”

Returning to FIG. 10, in decision block 430, it is decided whether the new PRT value exceeds the threshold value. The decision in decision block 430 is “YES” when the new PRT value exceeds the threshold value. On the other hand, the decision in decision block 430 is “NO” when the new PRT value does not exceed the threshold value.

When the decision in decision block 430 is “YES,” in block 440, an alert is generated. The alert may notify a developer to investigate why the PRT is unacceptably long. Alternatively, the alert may automatically trigger corrective actions. Then, the method 400 returns to block 410 to receive a new value for the PRT.

When the decision in decision block 430 is “NO,” the method 400 returns to block 410 to receive a new value for the PRT.

The method 400 may be performed continuously or occasionally (e.g., periodically).

The method 400 may be performed with respect to multiple pages simultaneously.

### Computing Device

FIG. 12 is a diagram of hardware and an operating environment in conjunction with which implementations of the system 100 (including the server computing device 110, the client computing devices 120A-120D, the website analysis computing device 130, the external application monitoring computing device 140, and the network 150) illustrated in FIG. 1 as well as the methods 200 (see FIG. 4), 300 (see FIG. 5), and 400 (see FIG. 10) may be practiced.

The description of FIG. 12 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 12 includes a general-purpose computing device in the form of a computing device 12. The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including an operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 12 include a local-area network (LAN) 51 and a wide-area network (WAN) 52. Such networking environments are commonplace in offices, enterprise-wide computer networks, intranets, and the Internet.

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The network 150 may include any of the aforementioned networking environments.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of the method 200 (see FIG. 4), the method 300 (see FIG. 5), and/or the method 400 (see FIG. 10). Such instructions may be stored on one or more non-transitory computer-readable media.

When the computing device 12 is used to implement the client computing devices 120A-120D, the website analysis computing device 130, and/or the external application monitoring computing device 140, the system memory 22 may store computer executable instructions operable to implement a conventional web browser. Such instructions may be stored on one or more non-transitory computer-readable media.

When the computing device 12 is used to implement the server computing device 110, the system memory 22 may store computer executable instructions operable to implement a conventional web server. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-implemented method for use with a page having a page response time and an amount of actual revenue generated over a period of time, the method comprising:
determining a target revenue for the page for the period of time;
determining a percentage of lost revenue as a function of the amount of actual revenue and the target revenue;
determining an attribution level that indicates a portion of the percentage of lost revenue that is attributable to the page response time; and
determining the portion of the percentage of lost revenue that is attributable to the page response time as a function of the percentage of lost revenue and the attribution level.

2. The method of claim 1, further comprising:
if the portion of the percentage of lost revenue that is attributable to the page response time exceeds a threshold value, taking a corrective action to reduce the page response time.

3. The method of claim 1 for use with a plurality of data samples, each sample comprising an observed page response time associated with a value of a performance metric, wherein determining the attribution level further comprises:
performing a statistical analysis on the data samples to obtain a model that expresses the performance metric as a function of the observed page response time; and
determining the attribution level based on the model.

4. The method of claim 1 for use with a plurality of data samples, each sample comprising an observed page response time associated with a value of a performance metric, wherein determining the attribution level further comprises:
selecting groups of samples from the plurality of data samples;
for each of the groups, performing a statistical analysis on the data samples of the group to generate a model that expresses the performance metric as a function of the observed page response time; and
determining the attribution level based on the models generated for the groups.

5. A computer-implemented method for use with a page associated with a percentage of lost revenue, the method comprising:
obtaining first values of a performance metric and first values of a page response time for the page over a first period of time;
determining at least one attribution level based on the first values of the performance metric and the first values of a page response time for the page, the at least one attribution level indicating how much of a change in the performance metric is attributable to a change in the page response time;
determining a threshold page response time based at least in part on the at least one attribution level and the percentage of lost revenue;
obtaining second values of the page response time for the page over a second period of time;
determining whether the second values of the page response time exceed the threshold page response time; and
when it is determined that the second values of the page response time exceed the threshold page response time, taking a corrective action to reduce the page response time for the page.

6. The method of claim 5, wherein the page response time is at least one of the following:
a total page response time;
a perceived render time;
a document object model ready time;
a time to first byte;
a page abort time; and
a page load time.

7. The method of claim 5, wherein the performance metric is at least one of the following:
a bounce rate;
an add rate;
an order completion rate; and
a search result click-through rate.

8. The method of claim 5, wherein the corrective action comprises generating an alert.

9. A system for use with a client computing device, the system comprising:
an application server configured to transmit a page to the client computing device;
a first application monitoring computing device connected to the application server and configured to obtain values of a performance metric associated with the page; and
a second application monitoring computing device configured to determine values of a page response time for the page and transmit them to the first application monitoring computing device, which is further configured to:
determine a first relationship indicating by how much changes in the value of the performance metric are attributable to changes in the value of the page response time;
determine a second relationship indicating by how much losses in revenue are attributable to changes in the value of the performance metric;
determine a third relationship indicating by how much losses in revenue are attributable to changes in the value of the page response time based at least in part on the first and second relationships;
obtain a threshold amount of revenue;
determine a threshold page response time based at least in part on the threshold amount of revenue and the third relationship; and
generate a display displaying the values of the page response time and the threshold page response time.

10. The system of claim 9 wherein the page is a webpage.

11. The system of claim 9 wherein the page is a page of a mobile application.

12. A system for use with a client computing device and an application monitoring computing device, the system comprising one or more computing devices that when operated alone or together are configured to:
transmit a webpage to the client computing device;
receive values of a page response time observed for the webpage from the application monitoring computing device;
obtain values of a performance metric associated with the webpage;
determine a first relationship indicating by how much changes in the value of the performance metric are attributable to changes in the value of the page response time;
determine a second relationship indicating by how much losses in revenue are attributable to changes in the value of the performance metric;
determine a third relationship indicating by how much losses in revenue are attributable to changes in the value of the page response time based at least in part on the first and second relationships;
obtain a threshold amount of revenue;
determine a threshold page response time based at least in part on the threshold amount of revenue and the third relationship; and
determine when the values of the page response time indicate the page is requiring an unacceptable amount of time to load or render based on the threshold page response time.

13. The system of claim 12, wherein the webpage is a routing page and the performance metric is a bounce rate.

14. The system of claim 12, wherein the webpage is a product page and the performance metric is an add rate.

15. The system of claim 12, wherein the webpage is a shopping cart page and the performance metric is an order completion rate.

16. The system of claim 12, wherein the webpage is a search page and the performance metric is a search result click-through rate.

17. The system of claim 12, wherein the page response time is at least one of the following:
a total page response time;
a perceived render time;
a document object model ready time;
a time to first byte;
a page abort time; and
a page load time.
